(19) United States
(12) Patent Application Publication
(10) Pub. No.: US 2010/0325054 A1
(43) Pub. Date: Dec. 23, 2010

(54) METHOD AND APPARATUS FOR BUSINESS INTELLIGENCE ANALYSIS AND MODIFICATION

(75) Inventors: Scott Currie, Greer, SC (US); Kang Su Gatlin, Seattle, WA (US)

Correspondence Address: DORITY & MANNING, P.A., POST OFFICE BOX 1449, GREENVILLE, SC, 29602-1449, US

(73) Assignee: VARIGENCE, INC., Greer, SC (US)

(21) Appl. No.: 12/817,281

(22) Filed: Jun. 17, 2010

Related U.S. Application Data
(60) Provisional application No. 61/268,819, filed on Jun. 18, 2009.

(51) Int. Cl. G06Q 10/00

(52) U.S. Cl. 705/301

(57) ABSTRACT

Systems and methods for analyzing business intelligence workflow are disclosed. The systems and methods are configured to generate a business intelligence workflow representation associated with a business intelligence asset. A given piece of business intelligence data can be queried and the system and method can generate a workflow slice that represents the portion of the business intelligence workflow that contributes to the specific piece of business intelligence data. The workflow slice can be modified, and reintegrated or merged back into the full business intelligence workflow. The modifications can be validated to ensure that no other business intelligence data are modified.

### PRIORITY CLAIM

This application claims the benefit of priority of U.S. Provisional Patent Application No. 61/268,819, filed Jun. 18, 2009, which is incorporated herein by reference for all purposes.

### FIELD

The present invention relates generally to business intelligence and more particularly to analysis and development of business intelligence assets.

### BACKGROUND

Business intelligence generally encompasses computer based techniques and methods for analyzing, locating, and manipulating business data, including sales data, cost data, income data, margin data, and other suitable data. Business intelligence systems and methods can provide useful tools for enhancing business decision making processes.

Business intelligence systems and processes generally rely on and manipulate complex business intelligence assets, such as relational databases, data warehouses, data marts, multidimensional databases, extract/transform/load (ETL) packages, analytical report definitions, and other suitable assets to generate useful business intelligence data. Business intelligence data can include various measures, attributes, dimensions, measure groups, database tables, column and row values, indexes, keys, data quality, annotations, ownership, deployment information, and any other suitable data or metadata. Sophisticated business intelligence systems can involve extremely complex workflow and can be difficult to design, build and maintain. Moreover, changes to portions of the business intelligence workflow can be difficult to implement without affecting other business intelligence data. Indeed, global program representations are extremely difficult to maintain even for the most skilled in the field.

Thus, a solution is needed that provides the capability to easily visualize and manipulate complex business intelligence workflow. A solution that allows a user to visualize a portion of the business intelligence workflow associated with a specific piece of business intelligence data would be particularly useful. A solution that provides for the manipulation of specific aspects of the business intelligence workflow without affecting other parts of the workflow would also be particularly useful.

### SUMMARY

Aspects and advantages of the invention will be set forth in part in the following description, or may be obvious from the description, or may be learned through practice of the invention.

One exemplary embodiment of the present disclosure is directed to a method of analyzing business intelligence workflow. The method includes receiving electronic signals associated with a business intelligence asset, such as a relational database, data warehouse, data mart, multidimensional database (OLAP cube), an extract/transform/load (ETL) package, an analytical report definition or other suitable business intelligence asset, and analyzing the electronic signals associated with the business intelligence asset to determine a business intelligence workflow. The method further includes generating a business intelligence workflow representation based at least in part on the business intelligence workflow and displaying the business intelligence workflow representation on an electronic display device.

In a variation to this exemplary embodiment of the present disclosure, analyzing the electronic signals associated with the business intelligence asset can include analyzing the electronic signals associated with the business intelligence asset to generate a parse tree; generating an object model based at least in part on the parse tree; and generating a graphical representation of the business intelligence workflow representation based on the object model.

In another variation to this exemplary embodiment of the present disclosure, analyzing the electronic signals associated with the business intelligence asset can include performing static code analysis on the business intelligence asset to determine at least one use or definition relationship.

In another implementation of this exemplary embodiment, the method can include decomposing the business intelligence workflow representation into a plurality of tuples and determining the use or definition path associated with the business intelligence data based at least in part from the plurality of tuples.

In still another variation of this exemplary embodiment, the method can further include receiving a query related to business intelligence data associated with the business intelligence asset. The method can generate a work flow slice based on the query that provides a representation of the portion of the business intelligence workflow that contributes to the generation of the business intelligence data. In a particular implementation of this exemplary embodiment, generating the workflow slice can include performing static code analysis, such as a static single assignment analysis, on the business intelligence workflow to determine a plurality of nodes that comprise a use or definition relationship for the business intelligence data. The plurality of nodes can be represented in the workflow slice.

In yet another variation of this exemplary embodiment, the method can include receiving a requested modification to the workflow slice. For instance, the method can include receiving a requested modification by receiving a modification to a visual representation of the workflow slice on the electronic display device. The method can further include modifying the workflow slice and the business intelligence workflow based on the requested modification. In a particular implementation, modifying the business intelligence workflow can be performed by generating new variables or transformations associated with the business intelligence data.

In a further variation of this exemplary embodiment, the method can include performing a validation check to ensure that the requested modification to the workflow slice does not affect other business intelligence data. If the requested modification to the workflow slice affects other business intelligence data, the method can further include duplicating a portion of the business intelligence asset associated with the workflow slice to generate a duplicate business intelligence asset subset, and modifying the duplicate business intelligence asset subset based on the requested modification.

Another exemplary embodiment of the present disclosure is directed to an electronic device that includes at least one input device, at least one electronic display device, at least one processing device, and at least one memory. The memory includes computer readable instructions for execution by the at least one processing device. The at least one processing device is configured to receive electronic signals associated with a business intelligence asset, analyze the electronic signals to determine a business intelligence workflow associated for the business intelligence asset, generate a business intelligence workflow representation based on the business intelligence workflow, and display the business intelligence workflow representation on the at least one electronic display device.

In a variation of this exemplary embodiment, the at least one input device can be configured to receive a query related to business intelligence data associated with the business intelligence asset. The at least one processor can be configured to generate a workflow slice based on the query and to display the workflow slice on the at least one electronic display device.

In another variation of this exemplary embodiment, the at least one input device can be configured to receive a requested modification to the workflow slice. The at least one processor can be configured to modify the workflow slice and the business intelligence workflow based on the requested modification. The at least one processor can be further configured to perform a validation check to ensure the requested modification to the workflow slice does not affect other business intelligence data.

A further exemplary embodiment of the present disclosure is directed to a computer readable medium comprising executable instructions configured to control a processing device to receive electronic signals associated with a business intelligence asset; analyze the electronic signals associated with the business intelligence asset to determine a business intelligence workflow for the business intelligence asset; generate a business intelligence workflow representation based at least in part on the business intelligence workflow; and display the business intelligence workflow representation on an electronic display device.

In a variation of this exemplary embodiment, the executable instructions can be further configured to control a processing device to receive a query related to business intelligence data associated with the business intelligence asset and to generate a workflow slice based on the query. In a further variation of this exemplary embodiment, the executable instructions are further configured to receive a requested modification to the workflow slice and to modify the workflow slice and the business intelligence workflow based on the requested modification. In still a further variation of this exemplary embodiment, the executable instructions are configured to control a processing device to perform a validation check to ensure that the requested modification to the workflow slice does not affect other business intelligence data.

Variations and modifications can be made to these exemplary embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a flow diagram of an exemplary method according to an exemplary embodiment of the present disclosure;

FIG. 2 depicts a block diagram of an exemplary system according to an exemplary embodiment of the present disclosure;

FIG. 3 depicts an exemplary business intelligence workflow representation associated with an exemplary ETL package;

FIG. 4 depicts an exemplary visual representation of a workflow slice associated with exemplary business intelligence data for the ETL package of FIG. 3;

FIG. 5A depicts a portion of a plurality of exemplary tuples comprising use and definition information associated of the business intelligence workflow representation of FIG. 3;

FIG. 5B depicts a portion of a plurality of exemplary tuples comprising use and definition information associated of the business intelligence workflow of the business intelligence workflow representation of FIG. 3; and

FIG. 6 depicts an exemplary system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The technology discussed herein makes reference to processors, servers, memories, databases, software applications, and/or other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein may be implemented using a single server or processor or multiple such elements working in combination. Databases and other memory/media elements and applications may be implemented on a single system or distributed across multiple systems. Distributed components may operate sequentially or in parallel. All such variations as will be understood by those of ordinary skill in the art are intended to come within the spirit and scope of the present subject matter.

When data is obtained or accessed between a first and second computer system, processing device, or component thereof, the actual data may travel between the systems directly or indirectly. For example, if a first computer accesses a file or data from a second computer, the access may involve one or more intermediary computers, proxies, or the like. The actual file or data may move between the computers, or one computer may provide a pointer or metafile that the second computer uses to access the actual data from a computer other than the first computer.

The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein also may be implemented by hard-wired logic or other circuitry, including, but not limited to application-specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods.

As noted above, such devices may access one or more computer-readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

Generally, embodiments of the present disclosure are directed to systems and methods that provide the capability to view and modify business intelligence workflow. A user can generate a workflow slice that corresponds to the generation of specific business intelligence data, such as measures, attributes, dimensions, measure groups, database tables, column and row values, indexes, keys, data quality, annotations, ownership, deployment information, and any other suitable data or metadata, in the business intelligence workflow. The full business intelligence workflow and a plurality of workflow slices can be presented simultaneously. The workflow slice can be edited or otherwise modified, for instance, by modifying a visual representation of the workflow slice. The resulting slice can then be merged or reintegrated back into the original business intelligence workflow and a validation check can be performed to validate and/or guarantee that the modified workflow slice does not affect unintended business intelligence data or other business intelligence assets. Modifications performed on any workflow slice or the business intelligence workflow can be instantly seen in the representation of other workflow slices.

In this manner, the subject matter of the present disclosure can provide the capability for reorganization of the business intelligence workflow for the purposes of analysis, optimization, presentation, or other suitable purpose, while preserving semantics of the business intelligence workflow and any workflow slices. This allows users to build extremely sophisticated business intelligence workflows using simple, scoped views, yielding fewer bugs and greater productivity. Embodiments of the present disclosure further allow larger global representations to be developed and maintained.

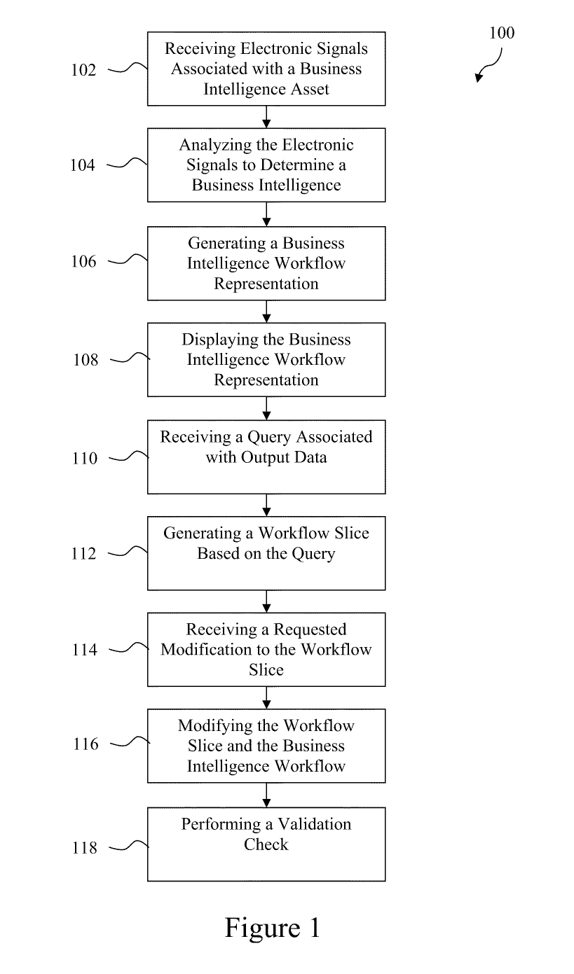

FIG. 1 depicts a flow diagram of an exemplary method 100 according to an exemplary embodiment of the present disclosure. At 102, the method 100 includes receiving electronic signals associated with a business intelligence asset. The business intelligence asset can be a relational database, data warehouse, data mart, multidimensional database (OLAP cube), an extract/transform/load (ETL) package, an analytical report definition or other suitable business intelligence asset. Those of ordinary skill in the art, using the disclosures provided herein, should understand that any business intelligence asset can be used without deviating from the scope of the present invention.

At 104, the method 100 includes analyzing the electronic signals associated with the business intelligence asset to determine the business intelligence workflow. Analyzing the electronic signals can be performed in a variety of methods, so long as business intelligence workflow is appropriately calculated. For instance, in a particular embodiment, code authored in a Business Intelligence Markup Language (BIML) that fully specifies schema and type information is analyzed to retrieve dataflow information. If the BIML for a dataflow item is not available or is incomplete, schema information can be read directly from the business intelligence asset.

Parsing the BIML can include expanding all templates and static control flow blocks to produce a flat version of the BIML file. A standard XML parser can be used to create an XML parse tree. The XML parse tree can be run through a language-specific processor to create an object model that includes a symbol table and all defined dataflow items. All references to data flow items are resolved using the symbol table.

At 106, the method 100 can include generating a business intelligence workflow representation based on the business intelligence workflow. The business intelligence workflow representation can take on many forms, such as a flow chart, syntax tree, or other graphical representation. In a particular embodiment, the business intelligence workflow representation can be generated by passing an object model to a graph constructor that computes nodes, edges, and relevant relationships for the business intelligence workflow. The graph can be flattened so that all nested subgraphs are collapsed into a single graph. Subgraphs can be inserted into their parents with relevant prologue and epilogue nodes. The nodes from the flattened graph can be collapsed into basic blocks. This transforms all linear segments of nodes into a single node (which is generally equivalent for dataflow analysis purposes). Finally, the basic block nodes can be passed to dataflow tuple providers that supply the variables defined by each dataflow item.

At 108, the method 100 includes displaying the business intelligence workflow representation on an electronic display device. This allows a user to easily view complex intelligence workflow associated with the business intelligence asset.

At 110, the method 100 includes receiving a query associated with business intelligence data for the business intelligence workflow. For instance, a user can specify a specific piece of business intelligence data associated with the business intelligence asset. At 112, the method 100 generates a workflow slice based on the query. The workflow slice provides a representation of the portion of the business intelligence workflow that contributes to the generation of the specific piece of business intelligence data.

The workflow slice can be generated by performing static code analysis on the business intelligence workflow to determine a plurality of nodes that include a use or definition relationship associated with the business intelligence data. In a particular embodiment, static single assignment analysis can be performed to generate a workflow slice. However, any suitable algorithm that gives the use/definition path is sufficient. The workflow device can be displayed to a user on an electronic display device so that a user can easily visualize aspects of the business intelligence workflow that contribute to the generation of the queried business intelligence data. Multiple workflow slices can be displayed simultaneously, along with the full business intelligence workflow.

At 114, the method 100 includes receiving a requested modification to the workflow slice. A requested modification can be made by modifying a visual representation of the workflow slice or the underlying business intelligence workflow representation. The requested modification can also be performed using textual editors, visual designers, or programmatically. At 116, the method 100 modifies the workflow slice and the underlying business intelligence workflow based on the requested modification. As will be discussed in more detail below, the changes to the workflow slice or the business intelligence workflow can be performed non-destructively or destructively.

At 118, the method performs a validation check to ensure that changes done to the slice do not affect other business intelligence data. If other business intelligence data are affected, the methodology according to embodiments of the present disclosure can duplicate a portion of the business intelligence asset associated with the workflow slice to generate a duplicate business intelligence asset subset, Modifications can then be made to the business intelligence asset subset to avoid affecting other data outputs.

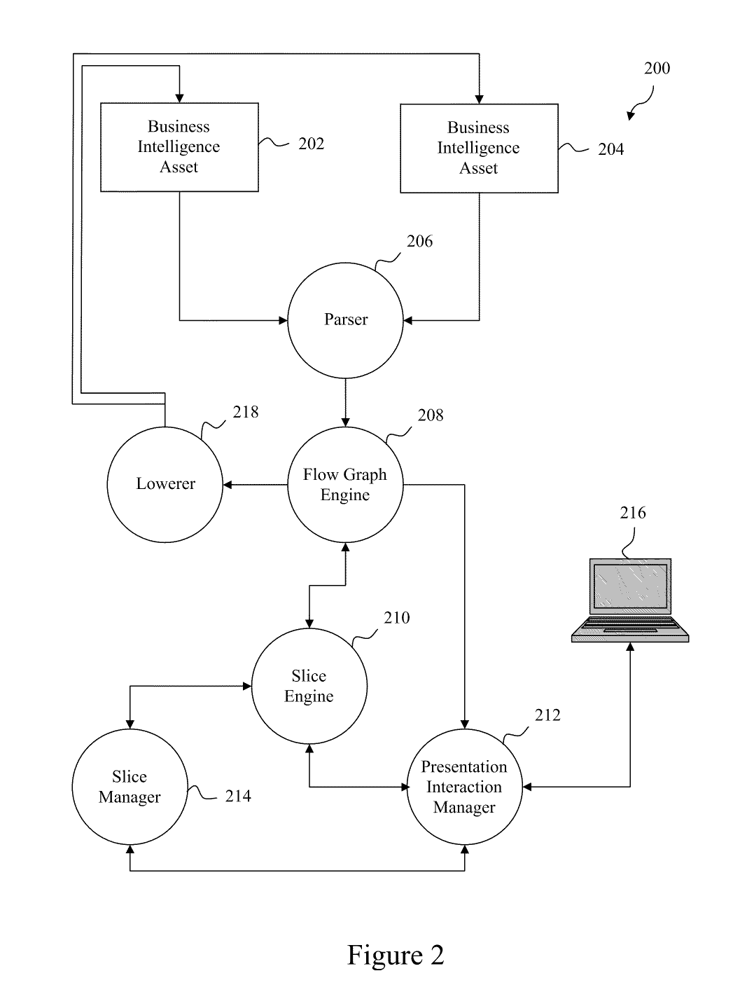

Referring now to embodiments of the present disclosure in more detail, FIG. 2 depicts a block diagram of a system 200 according to an exemplary embodiment of the present disclosure. Business intelligence assets 202 and 204 represent inputs to the system 200. Business intelligence asset 202 can be any suitable asset, such as, for instance, a data warehouse cube. Business intelligence asset 204 can similarly be any suitable asset, such as, for instance, an ETL package. While two business intelligence assets are illustrated in FIG. 2, those of ordinary skill in the art should understand that more or less business intelligence assets can be input into system 200 as desired.

System 200 includes a parser 206 that is configured to parse business intelligence assets 202 and 204 into an intermediate business intelligence workflow representation. System 100 can further include a flow graph engine 208, a slice engine 210, a presentation/interaction manager 212, and a slice manager 214. Flow graph engine 208 can be used to perform static code analysis on the business intelligence assets to construct the business intelligence workflow. Slice engine 210 can be used to compute workflow slices on-demand. Presentation/interaction manager 212 controls the user interaction and queries the flow graph engine 208 and slice engine 210 when needed. The slice manager 214 ensures that each slice presented to a user is accurate and up to date. The system further includes a lowerer 218 which is used to affect changes to the business intelligence assets 202 and 204 based on modifications to the business intelligence workflow and any workflow slices. An electronic device 216, such as a computing device, can include computer readable instructions to execute and/or implement the various aspects of system 200. The electronic device 216 can include least one input device, at least one electronic display device, at least one processing device, and at least one memory

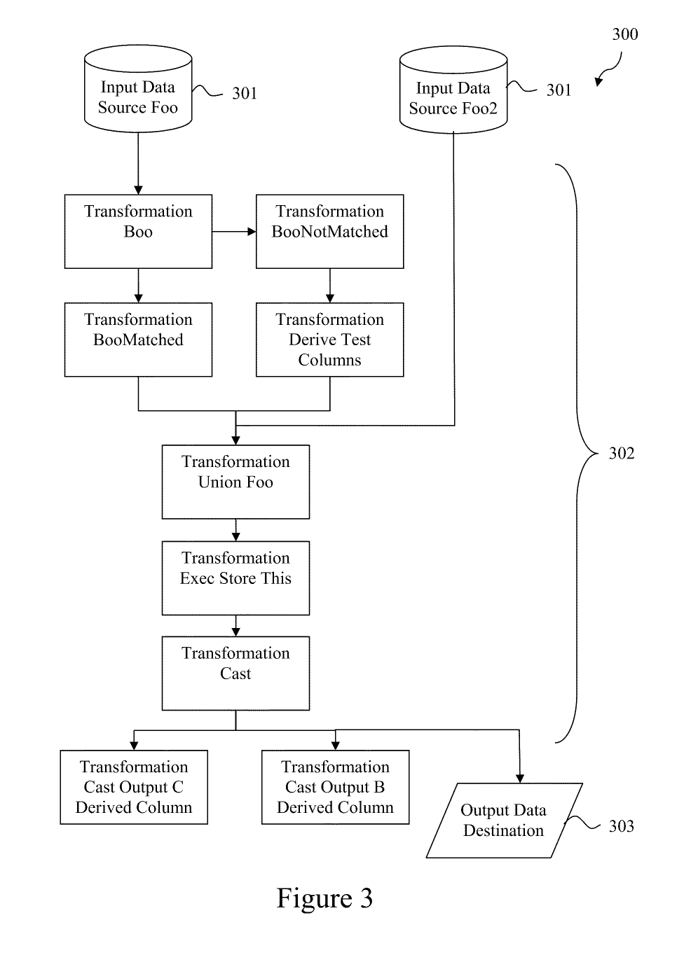

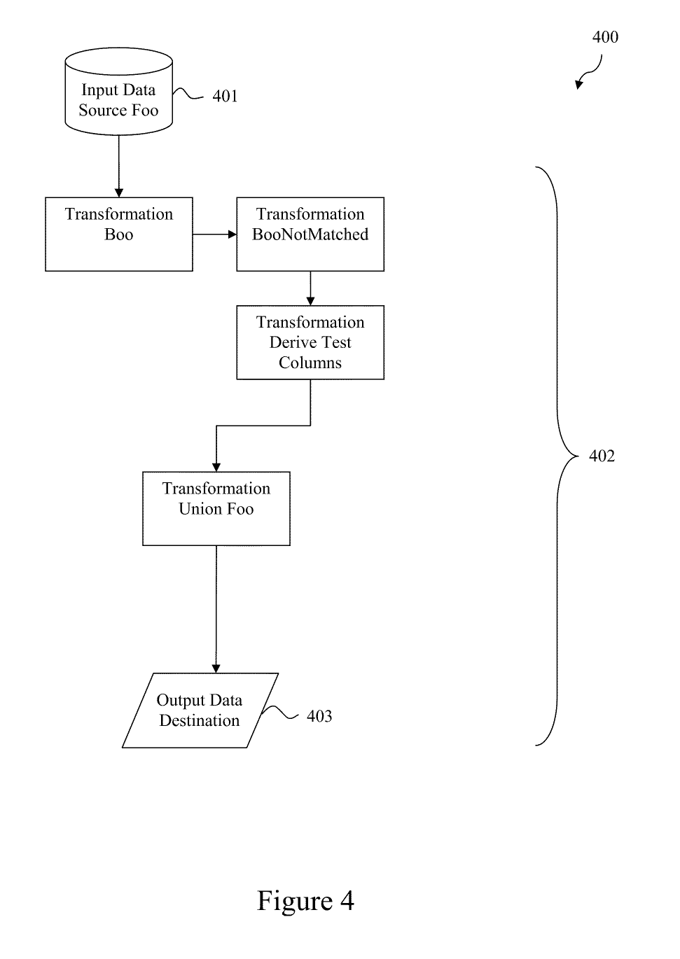

The flow diagram illustrated in FIG. 3 depicts an exemplary business intelligence workflow representation 300 for an exemplary ETL package. The flow diagram in FIG. 4 depicts an exemplary workflow slice 400 associated with business intelligence data for the business intelligence workflow illustrated in FIG. 3. Blocks 301 of FIG. 3 represent the input data sources for the full business intelligence workflow, while block 401 of FIG. 4 represents the input data source for the corresponding workflow slice. FIG. 3 provides a visual representation of the set of transformations 302 for the full business intelligence workflow. FIG. 4 provides a visual representation of the set of transformations 402 for the corresponding workflow slice. Block 303 of FIG. 3 represents the business intelligence data destination for the full business intelligence workflow. Block 403 of FIG. 4 is the business intelligence data for the corresponding slice.

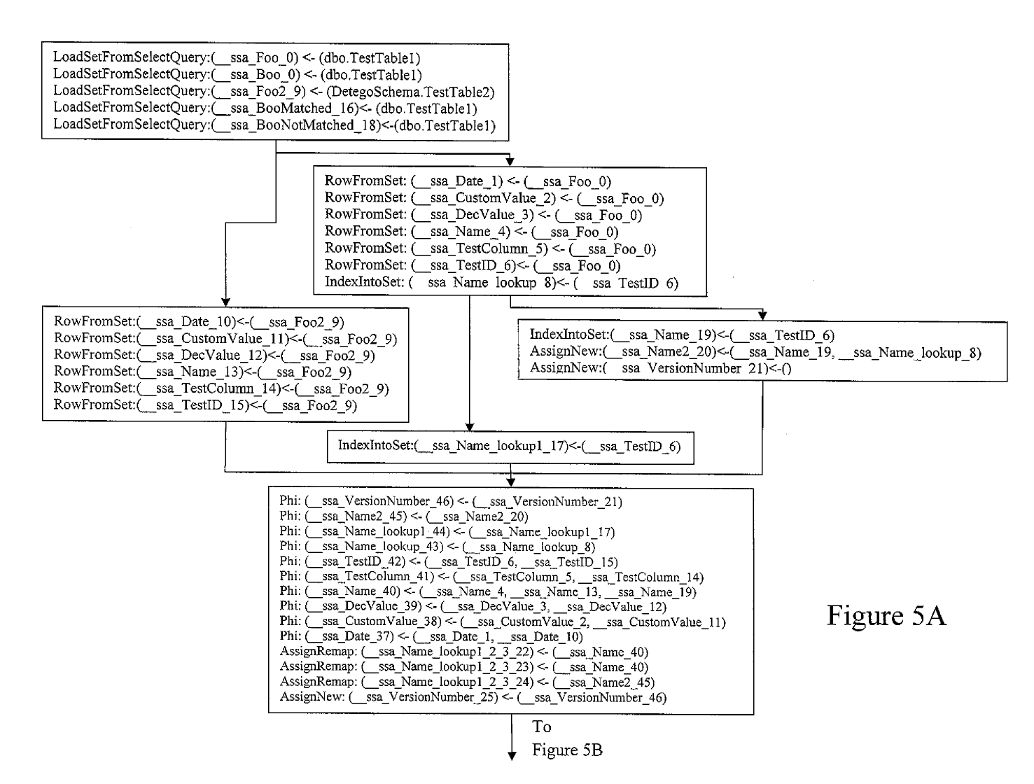

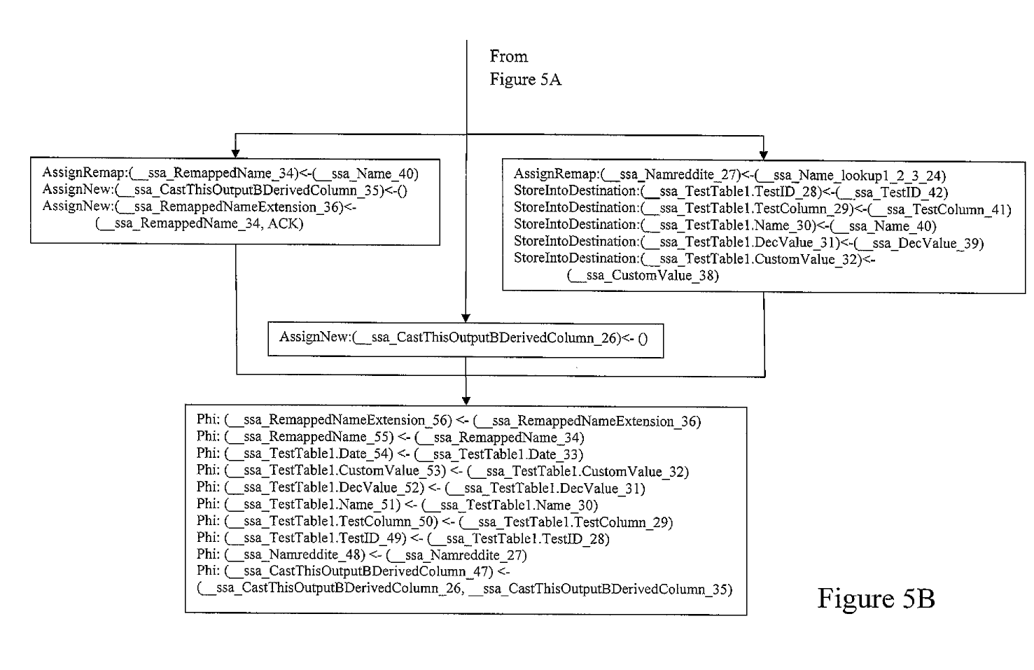

Referring now to FIGS. 5A and 5B, there is shown an exemplary underlying representation of the flow graph given in FIG. 2 with use/definition information calculated. In this case, the flow graph is decomposed into constituent tuples with Static Single Assignment (SSA) performed on it. Those of ordinary skill in the art, using the disclosures provided herein, should understand that any data flow algorithm that gives the use/definition path is sufficient, such as factored use/definition chains.

Referring back to FIG. 1, a user interacts with the electronic device 216 to load business intelligence asset 202 or business intelligence asset 204. The business intelligence assets 202 and 204 are loaded and analyzed by parser 206 to determine a business intelligence workflow and generate an intermediate business intelligence workflow representation. Those of ordinary skill in the art, using the disclosures provided herein, should understand that any representation where data flow information can be derived is sufficient, such as a control flow graph or abstract syntax tree.

The business intelligence workflow representation is given to the flow graph engine 208 which computes the flow of data through the business intelligence workflow using static use or definition information associated with the business intelligence workflow. For instance, the business intelligence workflow can be decomposed by flow graph engine 208 into constituent tuples that include use or definition information.

The business intelligence workflow representation with the associated flow information is given to the presentation/interaction manager 212 which can coordinate displaying the business intelligence workflow representation to a user via an electronic display device associated with electronic device 216.

A user can now request via the presentation/interaction manager 212, a workflow slice, or multiple workflow slices, that correspond to specific pieces of data or multiple specific pieces of data associated with the business intelligence asset 202 or 204. The presentation/interaction manager 212 receives the request and queries the slice engine 210. The slice engine 210 returns the portion of the business intelligence workflow that corresponds to the workflow slices that represent the data requested.

The slice engine 210 can also perform a backwards dataflow analysis on the business intelligence workflow. The analysis works from the node, representing the requested data, back to the input source nodes. Only those nodes that have a use/definition relationship to the requested data node are represented in the workflow slice. The workflow slices are then given to the flow graph engine 208 to wire up the slices and reconstruct the proper flow graphs for display. After flow graph reconstruction of the workflow slices have occurred, the flow graphs associated with the workflow slices are given to the presentation/interaction manager 212, and then displayed to user via an electronic display device associated with electronic device 216.

A user can now make changes to the workflow slices to change the associated data that the slices represent. This can be accomplished by modifying the graphical representation of workflow slice or modifying the underlying business intelligence workflow representation of the slice. Those of ordinary skill in the art, using the disclosures provided herein, should understand that any suitable method can be used for modifying a workflow slice.

The changes requested by the user can be implemented non-destructively or destructively, at the discretion of the user. If performed non-destructively, then modifying/removing a transformation or changing a variable name results in a new variable/transformation, with the existing variable/transformation unchanged. If performed destructively, then the slice engine 210 can perform a validation check to ensure that the changes done to the slice do not affect the other data outputs. Thus only specified data outputs are affected by changes made to a slice. The slice manager 214 ensures that all of the slices that are being simultaneously viewed and/or manipulated all reflect the most recent updates that have been performed on any workflow slice or the complete business intelligence workflow.

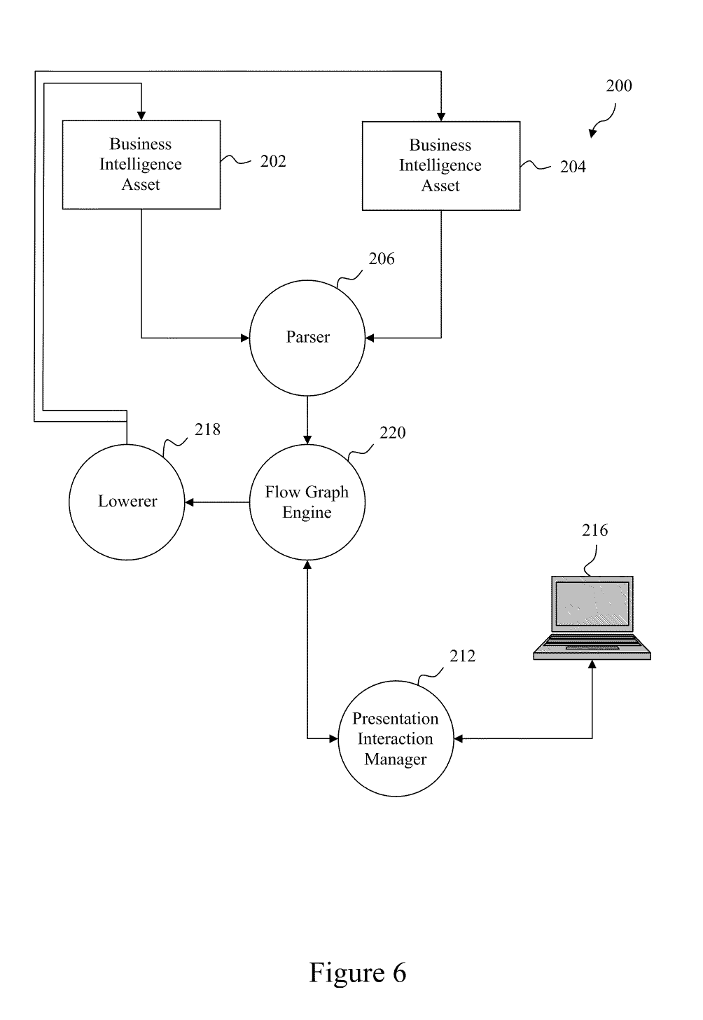

One of ordinary skill in the art will recognize that the inherent flexibility of computer-based systems allows for a great variety of possible configurations, combinations, and divisions of tasks and functionality between and among components of system 200. For instance, as shown in FIG. 6, an embodiment of the present disclosure can merge the flow graph engine 208 and slice engine 210 of FIG. 2 into a single a single flow graph/slice engine 220, ensuring that any changes made by the a user are instantly recognized by the aspects of the system that deal with both the business intelligence workflow representation and the workflow slices.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of analyzing business intelligence, comprising:
receiving electronic signals associated with a business intelligence asset;
analyzing the electronic signals associated with the business intelligence asset to determine a business intelligence workflow for the business intelligence asset;
generating a business intelligence workflow representation based at least in part on the business intelligence workflow; and
displaying the business intelligence workflow representation on an electronic display device.

2. The method of claim 1, wherein the business intelligence asset comprises at least one of a relational database, data warehouse, data mart, multidimensional database, an extract/transform/load (ETL) package, or an analytical report definition.

3. The method of claim 1, wherein analyzing the electronic signals associated with the business intelligence asset comprises:
analyzing the electronic signals associated with the business intelligence asset to generate a parse tree;
generating an object model based at least in part on the parse tree; and
generating a graphical representation of the business intelligence workflow representation based on the object model.

4. The method of claim 1, wherein analyzing the electronic signals associated with the business intelligence asset comprises performing static code analysis on the business intelligence asset to determine at least one use or definition path.

5. The method of claim 1, wherein the method further comprises:
receiving a query related to business intelligence data associated with the business intelligence asset; and
generating a workflow slice based on the query, the workflow slice providing a representation of the portion of the business intelligence workflow that contributes to the generation of the business intelligence data.

6. The method of claim 5, wherein generating a workflow slice comprises:
performing static code analysis on the business intelligence workflow to determine a plurality of nodes that comprise a use or definition relationship associated with the business intelligence data; and
representing the plurality of nodes in the workflow slice.

7. The method of claim 6, wherein the static code analysis comprises a static single assignment analysis.

8. The method of claim 7, wherein performing static code analysis on the business intelligence workflow representation comprises:
decomposing the business intelligence workflow representation into a plurality of tuples; and
determining the use or definition path associated with the business intelligence data based at least in part from the plurality of tuples.

9. The method of claim 5, wherein the method further comprises:
receiving a requested modification to the workflow slice;
modifying the workflow slice based on the requested modification; and
modifying the business intelligence workflow based on the requested modification to the workflow slice.

10. The method of claim 9, wherein receiving a requested modification to the workflow slice comprises receiving a modification to a visual representation of the workflow slice.

11. The method of claim 9, wherein modifying the business intelligence workflow representation based on the requested modification to the workflow slice comprises generating a new variable or transformation associated with the business intelligence data.

12. The method of claim 9, wherein the method further comprises performing a validation check to ensure that the requested modification to the workflow slice does not affect other business intelligence data.

13. The method of claim 12, wherein if the requested modification to the workflow slice affects other business intelligence data, the method further comprises:
duplicating a portion of the business intelligence asset associated with the workflow slice to generate a duplicate business intelligence asset subset; and
modifying the duplicate business intelligence asset subset based on the requested modification.

14. An electronic device, comprising:
at least one input device;
at least one electronic display device;
at least one processing device; and
at least one memory comprising computer readable instructions for execution by said at least one processing device, wherein said processing device is configured to receive electronic signals associated with a business intelligence asset, analyze the electronic signals associated with the business intelligence asset to determine a business intelligence workflow for the business intelligence asset, generate a business intelligence workflow representation based on the business intelligence workflow, and display the business intelligence workflow representation on said at least one electronic display device.

15. The electronic device of claim 14, wherein said at least one input device is configured to receive a query related to business intelligence data associated with the business intelligence asset, said at least one processor configured to generate a workflow slice based on the query, the workflow slice providing a representation of the portion of the business intelligence workflow that contributes to the generation of the business intelligence data, and further wherein the processor is configured to display the workflow slice on said electronic display device.

16. The electronic device of claim 14, wherein said at least one input device is configured to receive a requested modification to the workflow slice, said at least one processor configured to modify the workflow slice and the business intelligence workflow based on the requested modification.

17. The electronic device of claim 16, wherein said at least one electronic display device is configured to display a graphical representation of the workflow slice, said input device configured to receive the requested modification to the workflow slice when the graphical representation is modified on said at least one electronic display device.

18. The electronic device of claim 16, wherein said at least one processor is configured to perform a validation check to ensure the requested modification to the workflow slice does not affect other business intelligence data.

19. The electronic device of claim 18, wherein if said requested modification affects other business intelligence data, said processor is further configured to duplicate a portion of the business intelligence asset associated with the workflow slice to generate a duplicate business intelligence asset subset and to modify the duplicate business intelligence asset subset based on the requested modification.

20. A computer readable medium comprising executable instructions configured to control a processing device to:
receive electronic signals associated with a business intelligence asset;
analyze the electronic signals associated with the business intelligence asset to determine a business intelligence workflow for the business intelligence asset;
generate a business intelligence workflow representation based at least in part on the business intelligence workflow; and
display the business intelligence workflow representation on an electronic display device.

21. The computer readable medium of claim 20, wherein said executable instructions are further configured to control a processing device to:
receive a query related to business intelligence data associated with the business intelligence asset; and
generate a workflow slice based on the query, the workflow slice providing a representation of the portion of the business intelligence workflow that contributes to the generation of the business intelligence data.

22. The computer readable medium of claim 21, wherein said executable instructions are further configured to control a processing device to:
receive a requested modification to the workflow slice;
modify the workflow slice based on the requested modification; and
modify the business intelligence workflow based on the requested modification to the workflow slice.

23. The computer readable medium of claim 22, wherein said executable instructions are further configured to control a processing device to perform a validation check to ensure that the requested modification to the workflow slice does not affect other business intelligence data.

24. The computer readable medium of claim 23, wherein said executable instructions are further configured to control a processing device to duplicate a portion of the business intelligence asset associated with the workflow slice to generate a duplicate business intelligence asset subset, and to modify the duplicate business intelligence asset subset based on the requested modification if the requested modification to the workflow slice affects other business intelligence data.
